(19) United States
(12) Patent Application Publication
(10) Pub. No.: US 2011/0241460 A1
(43) Pub. Date: Oct. 6, 2011

(54) AXIAL FLUX MACHINE

(75) Inventors: Abdeslam Mebarki, Stamford (GB); Gurpreet Saini, Peterborough (GB); Gopinath Thelungupalayam Thiagarajan, Stamford (GB); Martin Shanel, Peterborough (GB); Adrian Bell, Oakham (GB); Richard Gray, Sleaford (GB); Neil Brown, Holbeach (GB)

(73) Assignee: CUMMINS GENERATOR TECHNOLOGIES LIMITED, Stamford (GB)

(21) Appl. No.: 13/054,350

(22) PCT Filed: Jul. 14, 2009
(86) PCT No.: PCT/GB09/01781

§ 371 Date: Jun. 10, 2011

(30) Foreign Application Priority Data
Jul. 16, 2008 (GB) 0813032.0
May 8, 2009 (GB) 0907982.3

(51) Int. Cl. H02K 1/28; H02K 7/14; H02K 5/20; H02K 5/18; H02K 15/02

(52) U.S. Cl. 310/64; 310/156.12; 310/75 R; 29/598

(57) ABSTRACT

An axial flux rotating electrical machine is disclosed, which comprises a stator sandwiched between two rotors. The machine comprises retention means for retaining magnets on the rotor, the retention means comprising a back plate with a plurality of protrusions which define a plurality of pockets for accommodating the magnets. The retention means is arranged such that the magnets can be inserted into the pockets and held therein, and the retention means with inserted magnets can be fixed to a rotor so as to retain the magnets axially and tangentially. A cooling jacket for the stator, and techniques for securing the stator to the machine, are also disclosed.

The present invention relates to an axial flux rotating electrical machine, such as a generator or motor. Aspects of the invention relate to techniques for retaining permanent magnets in an axial flux machine, techniques for cooling the stator in an axial flux machine, techniques for retaining the stator, and to a new rotor design for an axial flux machine.

Axial flux rotating electrical machines differ from conventional radial flux machines in that the magnetic flux between the rotor and the stator runs parallel to the mechanical shaft. Axial flux machines can have several advantages over radial flux machines, including compact machine construction, high power density, and a more robust structure. However various problems remain to be addressed, including magnet retention, stator retention, and cooling of the machine.

Previous techniques for retaining permanent magnets in axial flux machines include providing a retaining lip on the outer periphery of the rotor disc to counter centrifugal forces, and using adhesive to secure magnets to the rotor plate. However these techniques may be ineffective in retaining the magnets where high centrifugal forces are experienced.

WO 02/056443 discloses a spider assembly for fixing permanent magnets to a rotor disc in an axial flux machine. EP 1 503 478 discloses the use of wedge members to pin down the magnets and accommodate any tolerance. These techniques may be effective in correctly locating and retaining the magnets. However they are complex, and require a clean working environment and special preparations for rotor assembly. Furthermore, it has been found that in some cases the surface protection of the permanent magnets could become damaged, which may cause the magnetic material to degrade over time.

According to one aspect of the present invention there is provided retention means for retaining magnets on the rotor of an axial flux rotating electrical machine, the retention means comprising a back plate with a plurality of protrusions, the protrusions defining a plurality of pockets for accommodating the magnets, wherein the retention means is arranged such that the magnets can be inserted into the pockets and held therein, and wherein the retention means with inserted magnets can be fixed to the rotor so as to retain the magnets axially and tangentially.

The present invention can allow manufacture of the rotor disc to be simplified, by providing a retention means into which the magnets can be inserted prior to assembly of the rotor, and which can then form part of the rotor assembly so as to retain the magnets axially and tangentially. The present invention can also allow the magnets to be held securely without the need for separate fixtures for each magnet.

In one embodiment of the invention, at least some of the protrusions are in the form of ribs.

According to another aspect of the present invention there is provided retention means for retaining magnets on a rotor of an axial flux rotating electrical machine, the retention means comprising a plate with protruding ribs for holding the magnets.

The present invention may also provide the advantage that the magnets can be easily inserted into the retention means, and the risk of damaging the surface protection of the magnets may be reduced.

Preferably the protrusions at least partially define pockets into which the magnets may be inserted. For example, at least some of the protrusions may run in a substantially radial direction, and may define partial segments. This can allow magnets of a substantially trapezium shape to be accommodated (i.e. a quadrilateral with one pair of parallel sides, which may be straight or curved, and one pair of diverging sides). This may facilitate the spacing of the magnets around a rotor disc.

In order to absorb any variations in the size of the magnets, and to assist in securing the magnets within the pockets, at least some of the protrusions may comprise deformable fins which extend inwards. The fins are preferably arranged to press against the inserted magnets.

The retention means is preferably arranged to be mounted on the rotor of the machine with the magnets facing a back plate of the rotor. This can allow the magnets to be held firmly in place by the retention means. Preferably all of the magnets are inserted into a single retention means, although it would also be possible for two or more retention means to be provided.

Permanent magnets are often made from materials such as Neodymium Iron Boron (NdFeB). Such materials may rust or deteriorate quickly if exposed to contamination such as salty water or air. As a consequence, special coatings are often applied to the magnets in order to protect them. However it has been found that the coatings may become damaged during assembly or use of the machine. In order to address this problem, the retention means may be arranged such that, when the retention means is mounted on the rotor, the magnets are at least partially encased by the retention means and the rotor, and preferably completely encased. This can allow the magnets to be protected from mechanical damage and from contaminates such as sand or salt.

A rotor for an axial flux machine is typically disc shaped, and thus the plate may be a ring-shaped disc in order to facilitate mounting of the plate on the rotor. Alternatively, the retention means may be in the form of a semi-closed spider.

The retention means may further comprise means for retaining the magnets radially. For example, the retention means may further comprise a lip for retaining the magnets. As an example, an outer lip may run around the outside circumference of the plate, and may help to retain the magnets against centrifugal forces, possibly in combination with the lip arrangement of the rotor disc. In addition or alternatively the retention means may comprise an inner lip which runs around the inside circumference of the plate. The lip or lips in combination with the protrusions may define pockets into which the magnets may be inserted, which may facilitate retention of the magnets. The lip or lips may comprise deformable fins which extend inwards.

Preferably the protrusions and/or lip or lips protrude from the plate in a substantially axial direction (that is, parallel to the axis of the machine). The height of the protrusions and/or lips may be approximately equal to the thickness of the magnets which are to be accommodated. Alternatively, corresponding protrusions and/or lips may be provided on the rotor disc, and the total height of a protrusions or lip on the plate and the corresponding protrusions or lip on the rotor disc may be approximately equal to the thickness of the magnets. For example, the plate and the rotor disc may both comprise an outer lip, the total height of which is approximately equal to the thickness of the magnets.

The magnets may be permanent magnets, or they may be ferrous poles which become magnetized on application of an excitation field, as disclosed in WO 03/003546 the contents of which are incorporated herein by reference.

The retention means may further comprise a spacing ring for separating radially spaced magnets and/or ferrous poles. This may help to prevent flux leakage, for example between radially spaced magnets and ferrous poles, and may help in physically securing both parts.

According to another aspect of the present invention there is provided a rotor assembly for an axial flux rotating electrical machine, the rotor assembly comprising:
a rotor disc;
a plurality of permanent magnets; and
retention means in any of the forms described above.

The rotor disc may include a lip for retaining the magnets radially, and this may be provided in addition to or as an alternative to any lip on the retaining means.

WO 03/003546 discloses an axial flux machine in which each rotor disc has two permanent magnets diametrically opposite one another on its face adjacent the stator, and two pole pieces of non-magnetised ferromagnetic material diametrically opposite one another on the same face of the rotor disc. A control winding is carried by the stator in its central aperture. The control winding can be energized to establish a control field which establishes a closed loop of magnetic flux through each juxtaposed magnet and non-magnetised pole piece and thereby opposes armature reaction.

The arrangement disclosed in WO 03/003546 can allow control of the rotor's magnetic field. However, it may suffer from some or all of the problems discussed above, including the problems associated with magnet retention.

The rotor assembly of the present invention may therefore be arranged to allow control of the rotor field in the way described in WO 03/003546. Thus, the rotor assembly may further comprise a plurality of ferrous poles which are retained on the rotor by the retention means. Preferably, each ferrous pole is adjacent to a permanent magnet. The ferrous poles may allow control of the rotor field.

The rotor assembly may comprise two rotor discs for mounting on either side of a stator, and the rotor discs may be symmetrical. By providing symmetrical rotor discs, it may be possible to reduce the cost of casting and machining the rotors, which may reduce the manufacturing cost. Furthermore, assembly of the rotor may be made easier.

Each rotor disc may comprise a castellated connecting ring, and the castellated connected rings may be aligned to create air gaps in the rotor. In addition to simplifying the rotor design, this can allow more air flow during rotation of the rotor, which may improve the cooling. Alternatively, each rotor disc may have a continuous (non-castellated) connecting ring.

The rotor may further comprise an adaptor hub for connecting the rotor to an engine. The adaptor hub may be a separate piece which is connected to one of the rotor discs. As well as simplifying the rotor design, this can allow the axial flux machine to be connected to a number of different engines simply by replacing the adaptor hub.

According to another aspect of the invention there is provided a method of assembling a rotor for an axial flux rotating electrical machine, the method comprising inserting magnets into pockets in a retention means, offering the retention means with inserted magnets to a rotor disc, and fixing the retention means to the rotor disc such that the magnets are held between the rotor and the retention means in order to retain the magnets axially and tangentially.

The magnet retention means discussed above may be part of an enclosed axial flux machine. Enclosed machines have various advantages, including reduced susceptibility to contamination. However, enclosed machines have reduced air cooling, and thus alternative cooling solutions may need to be provided. In particular, cooling of stator windings has proved problematic.

According to another aspect of the invention there is provided a cooling jacket for a stator of an axial flux rotating electrical machine, the cooling jacket being arranged to cool the inside of the stator, the cooling jacket comprising a passage for the flow of coolant, wherein the passage comprises grooves which introduce turbulence into the flow of coolant.

By providing grooves which introduce turbulence into the flow of coolant, the transfer of heat from the stator to the coolant may be improved. Furthermore, it has been found that the use of grooves can allow turbulence to be introduced while causing a relatively low pressure drop in the coolant, compared to the case where for example protrusions are provided in the passage.

The grooves may introduce different amounts of turbulence in different parts of the passage. For example, the grooves may be arranged to introduce an increasing amount of turbulence through the passage in the direction of coolant flow. Preferably, the grooves are arranged such that a similar level of heat transfer is achieved throughout the cooling jacket. This may help to ensure uniform cooling of the stator, which may allow the machine to operate more efficiently and/or at a higher rating.

For example, some grooves may run at different angles to the flow of coolant from other grooves, and/or some grooves may be more closely spaced than others. In one embodiment, grooves running substantially parallel to the flow of coolant are provided in a first part of the cooling jacket (with regard to the flow of coolant), and grooves running substantially perpendicular to the flow of coolant are provided in a second part of the cooling jacket.

The cooling jacket is preferably hollow to provide the passage through which the coolant flows. In one embodiment, the cooling jacket is formed from two sections which, when pressed together, form an annular cavity. In this case the two sections may be sealed by at least one O-ring seal, and preferably two O-ring seals. The two sections may be at least partially held together by stator windings. This can allow the two sections to be joined together without the need for welding, which may reduce the manufacturing cost.

The cooling jacket may comprise a plurality of fins which extend beyond the circumference of the stator. The fins may conduct heat away from the stator windings and towards, for example, a coolant in the centre of the cooling jacket. Thus the fins may act as a heat sink for stator windings. This arrangement can thus help to cool the stator effectively.

The fins may be, for example, semi-cylindrical or any other suitable shape, and may lie on a ring around the outside of the cooling jacket. Preferably the fins define slots which accommodate stator windings. This may create a relatively large contact area between the windings and the fins, which may assist in cooling the windings.

Stators for axial flux machines may have overhang windings running around their outside circumference. Preferably the fins extend outwards radially such that, when the stator is wound, overhang windings rest on the fins. This may be achieved by ensuring that the stator windings are completely accommodated in the slots between the fins. In this way the fins may act as a heat sink for the overhang windings.

In order to cool windings on the inside of the stator, the cooling jacket may further comprise a plurality of fins which extend radially inward of the stator.

In an axial flux rotating electrical machine it is necessary to provide some means for holding the stator in place. Previously considered arrangements for holding the stator have involved the use of two retention ring components which are brought together around the stator. The retention ring components have teeth which clamp the stator in place. However, various problems have been identified with such arrangements. Firstly, the use of two retention rings requires two castings and multiple machined surfaces which increases the production cost of the machine. Secondly, the teeth which clamp the stator may experience eddy current losses as they are in the main magnetic field of the machine. Thirdly, when assembling the stator the retention ring may damage the stator end windings since it is in close contact with the stator. Fourthly, under short circuit conditions, the stator may rotate within the retention ring, damaging the windings.

In one embodiment of the invention, rather than clamping the stator in place, the cooling jacket is used to secure the stator assembly. A convenient way to do this may be to use some of the fins on the cooling jacket. Thus, at least some of the fins may be arranged for securing the stator to the machine. Such an arrangement may help to reduce eddy current losses due to the main rotor field, since it avoids the need for a clamp to have direct contact with the stator.

Preferably some of the fins extend outwards in a radial direction by a greater amount than the other fins. The extended fins may then be used for securing the cooling jacket to the machine. The extended fins may have holes for securing the cooling jacket to the machine. For example, the extended fins may be used to bolt, rivet or screw the cooling jacket to the machine. Thus a positive retention method, rather than clamping, may be used to retain the stator assembly, which may help to prevent stator rotation.

According to another aspect of the invention there is provided an axial flux rotating electrical machine comprising a machine housing, a stator, a cooling jacket in any of the forms described above, and an inlet pipe and an outlet pipe for supplying coolant to and from the cooling jacket, wherein the inlet pipe and outlet pipe are integrated with the machine housing. This may facilitate the supply of coolant to the cooling jacket, reduce the number of components, and simplify manufacture of the machine.

According to another aspect of the invention there is provided an axial flux rotating electrical machine comprising:
a stator;
a cooling jacket inside the stator for cooling the stator; and
stator windings around the stator and the cooling jacket;
wherein the cooling jacket comprises a plurality of independent protrusions which extend radially outwards through the stator windings and which secure the stator to the machine.

By providing a plurality of independent protrusions which extend radially outwards through the stator windings and which secure the stator to the machine, the stator assembly may be secured to the machine without the need for direct contact with the stator, which may help to reduce eddy current losses. Furthermore, a positive retention method is provided, which may help to prevent stator rotation. In addition, the stator windings can easily be wound on to the stator and cooling jacket, by locating the windings between the protrusions.

The protrusions may have holes for securing the cooling jacket to the machine. For example, the protrusions may be used to bolt, rivet or screw the cooling jacket to the machine. The protrusions may be in the form of the extended fins described above, or in some other form. The cooling jacket need not include the other fins described above.

The stator and/or cooling jacket may comprise open slots for accommodating the stator windings. This may facilitate winding of the stator windings.

The stator assembly may further comprise roll pins inserted between the cooling jacket and the stator. This may help to reduce the risk of stator rotation.

The machine may further comprise a retention ring, and the cooling jacket may be secured to the retention ring. The retention ring may be secured to the machine, or it may be integrated with the machine, for example, as part of a machine housing.

The retention ring may comprise a plurality of teeth aligned with the protrusions on the cooling jacket. This can allow the stator assembly to be held using a single retention ring, rather than being clamped between two retention rings, which may reduce the cost and complexity of the machine. Since the retention ring is fixed to the cooling jacket, rather than clamping the stator, the retention ring is not in the machine's main magnetic field. Thus this arrangement may help to reduce eddy current losses. Furthermore, since the retention ring is fixed to the cooling jacket rather than the stator, the risk of damaging the stator windings is reduced.

The machine may further comprise a machine housing, and the stator may be enclosed within and/or secured to the machine housing. The retention ring may be integrated with the machine housing, or some other form of mounting may be provided in the housing. By forming the retention features as an integrated part of the housing for the electrical machine, the ease of assembly may be improved and the part count and cost of manufacture may be reduced.

The machine may further comprise an inlet pipe and an outlet pipe for supplying coolant to and from the cooling jacket, and the inlet pipe and outlet pipe may be integrated with the machine housing. This may facilitate the supply of coolant to the cooling jacket, reduce the number of components, and simplify manufacture of the machine.

Where the axial flux machine is to be connected to or integrated with an engine, then it may be possible for the cooling jacket to be integrated with the engine's cooling system, so that the coolant which cools the engine is also passed through the cooling jacket to cool the axial flux machine. Thus the cooling jacket may be arranged to be connected to an engine cooling system. This can allow a single cooling system to be provided for both the engine and the machine, which may reduce the number of components, and help to provide a compact unit;

Thus, according to another aspect of the invention there is provided a generator set comprising:
an axial flux rotating electrical machine in any of the forms described above; and
an engine coupled to the electrical machine, the engine comprising a cooling system,
wherein the cooling jacket is connected to the engine cooling system to allow flow of coolant from the engine cooling system through the cooling jacket.

As discussed above, it may be desirable to produce an axial flux machine as an enclosed unit. If the axial flux machine is to be connected to an engine in order to operate as a generator set, then a further level of integration can be achieved by producing the engine and the machine as an enclosed unit. For example, the axial flux machine may replace the engine flywheel, and may sit inside the flywheel housing. This can reduce the number of components, and provide a highly compact unit.

Thus the engine may have a flywheel housing, and the electrical machine may be integrated in the engine flywheel housing.

As discussed above, it may be desirable to produce an axial flux machine as an enclosed unit, which may be integrated with an engine. While this can reduce the number of components and provide a highly compact unit, conventional rotor designs may suffer from poor rotor cooling when they are used in enclosed units.

Furthermore, conventional rotating electrical machines are designed to fit one type of engine, whereas it may be desirable to fit a machine to more than one type of engine. In addition, conventional rotor designs tend to be fairly complex.

According to another aspect of the invention there is provided an axial flux rotating electrical machine comprising retention means as described above, and/or a cooling jacket as described above, and/or a stator assembly as described above, and/or a rotor as described above.

According to another aspect of the invention there is provided a method of assembling an axial flux rotating electrical machine, the method comprising:
providing a stator assembly comprising two stator parts;
providing a cooling jacket, the cooling jacket comprising a plurality of independent radial protrusions;
placing the cooling jacket between the two stator parts;
winding stator windings around the stator and cooling jacket; and
securing the stator to the machine by means of the protrusions from the cooling jacket.

Features of one aspect of the invention may be provided with any other aspect. Any of the apparatus features may be provided as method features and vice versa.

Preferred features of the present invention will now be described, purely by way of example, with reference to the accompanying drawings, in which:

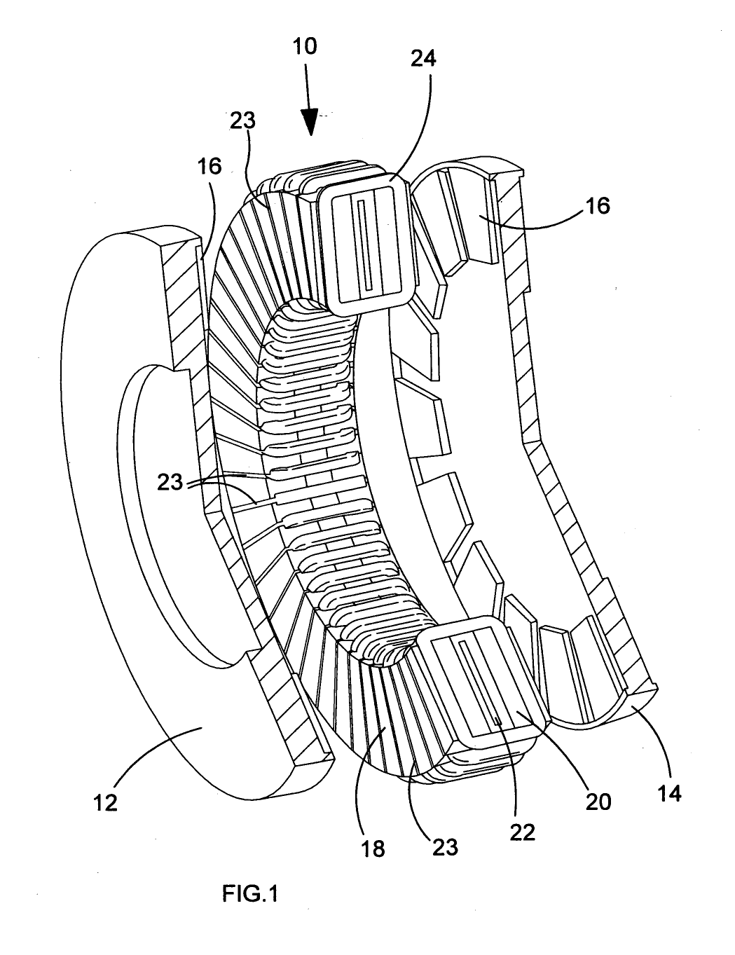

FIG. 1 shows parts of an axial flux rotating electrical machine;

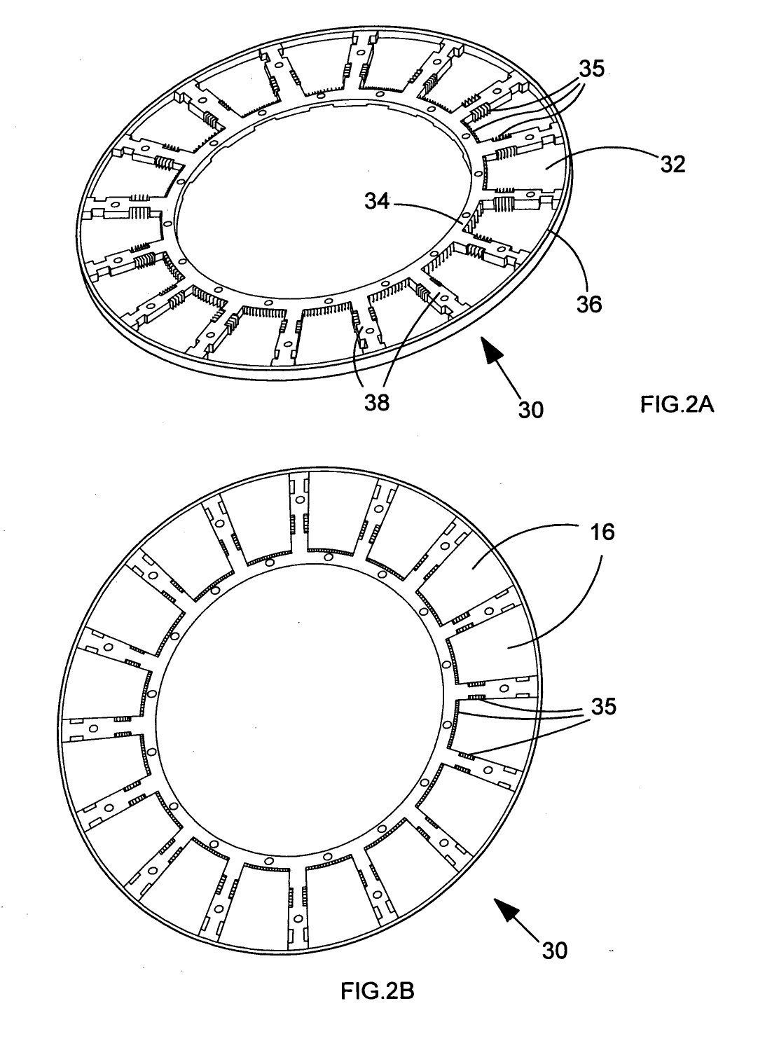

FIGS. 2A to 2D show a magnet retention plate;

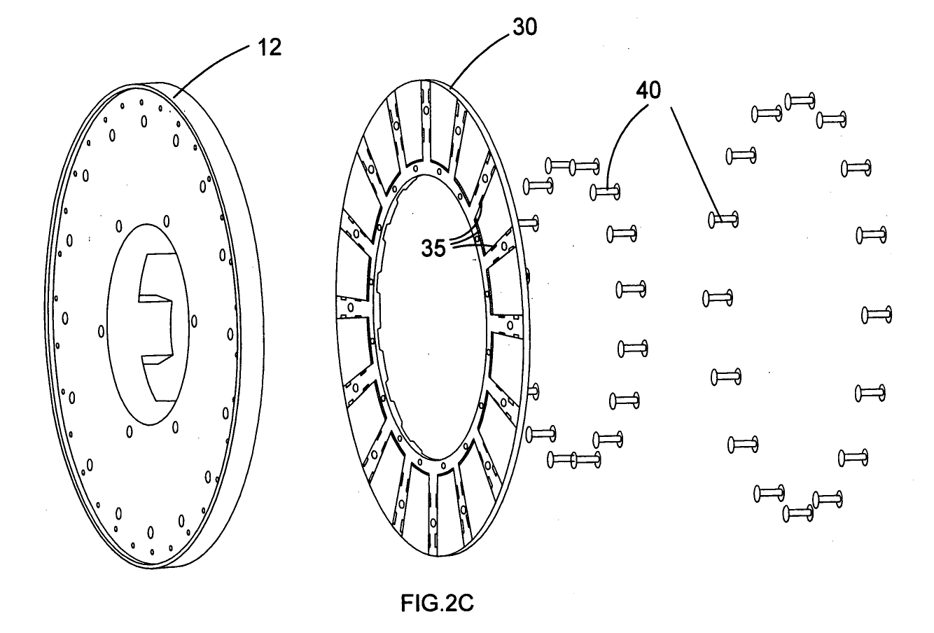

FIGS. 3A to 3C show parts of a stator and cooling jacket;

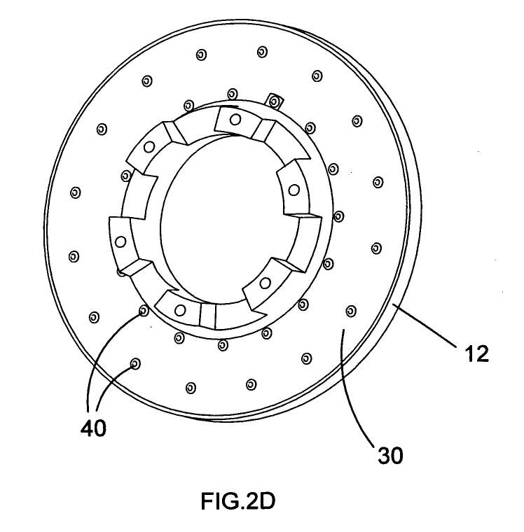

FIGS. 4A to 4E show an embodiment of a cooling jacket;

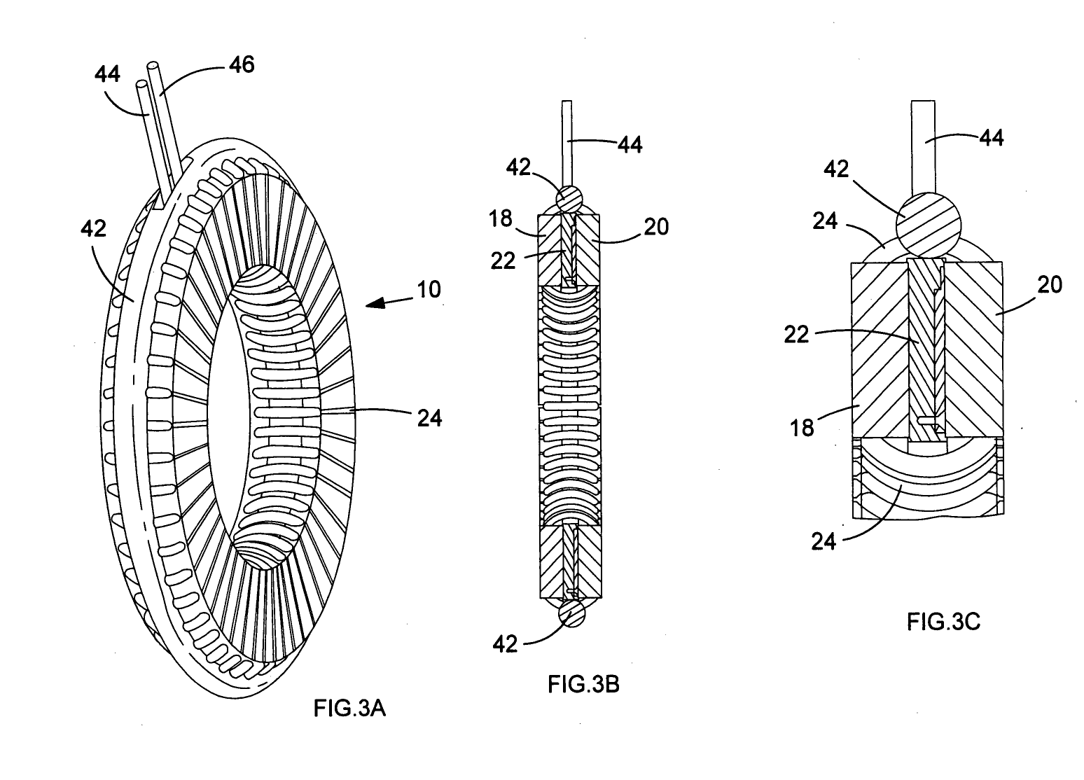

FIGS. 5A to 5D show parts of a stator retention assembly;

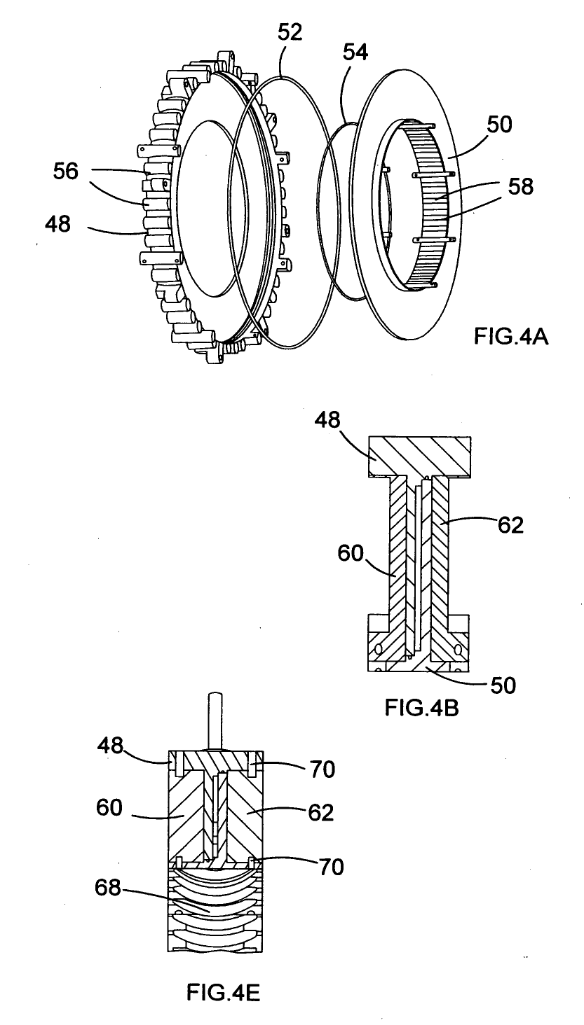

FIGS. 6A and 6B show a previously considered rotor design;

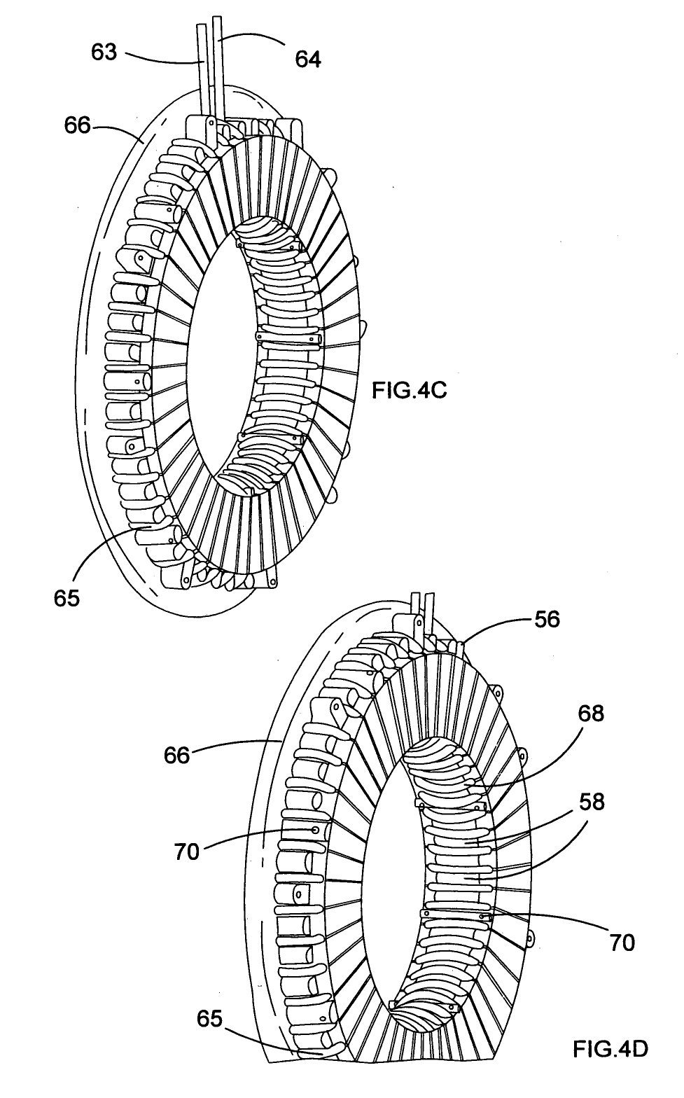

FIGS. 7A and 7B show parts of an improved rotor design;

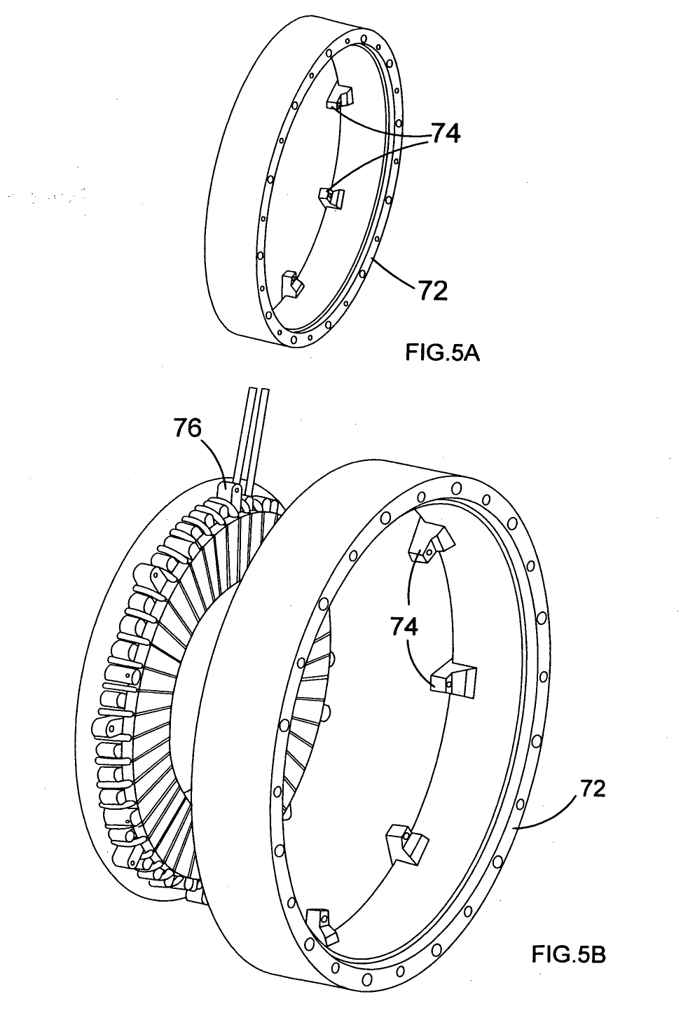

FIGS. 8A to 8C show another embodiment of a cooling jacket;

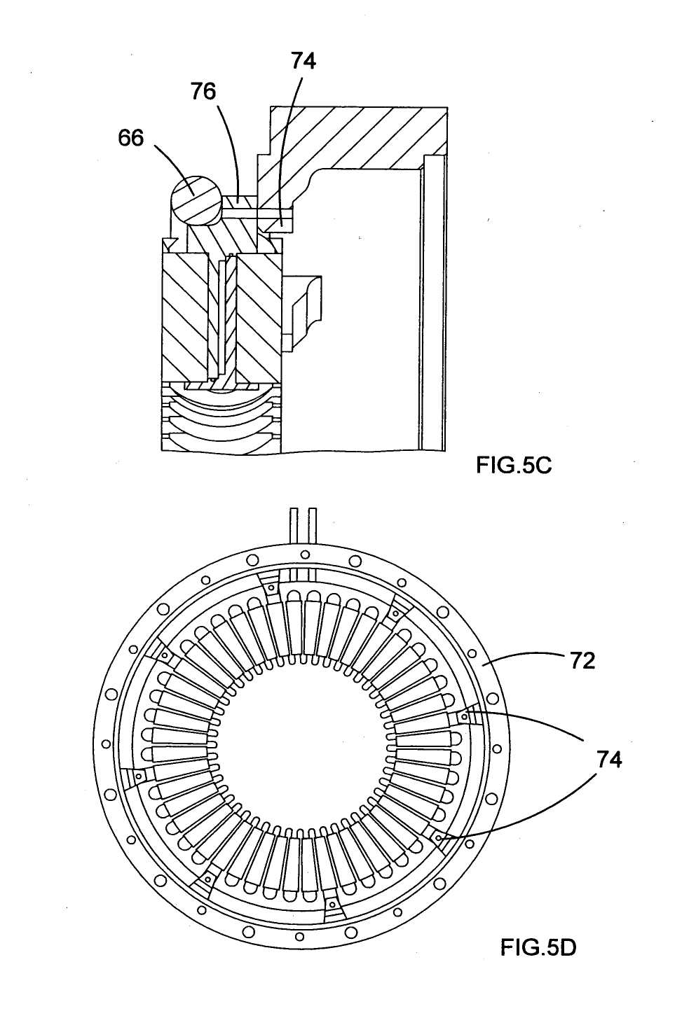

FIG. 9 shows another embodiment of a retention plate;

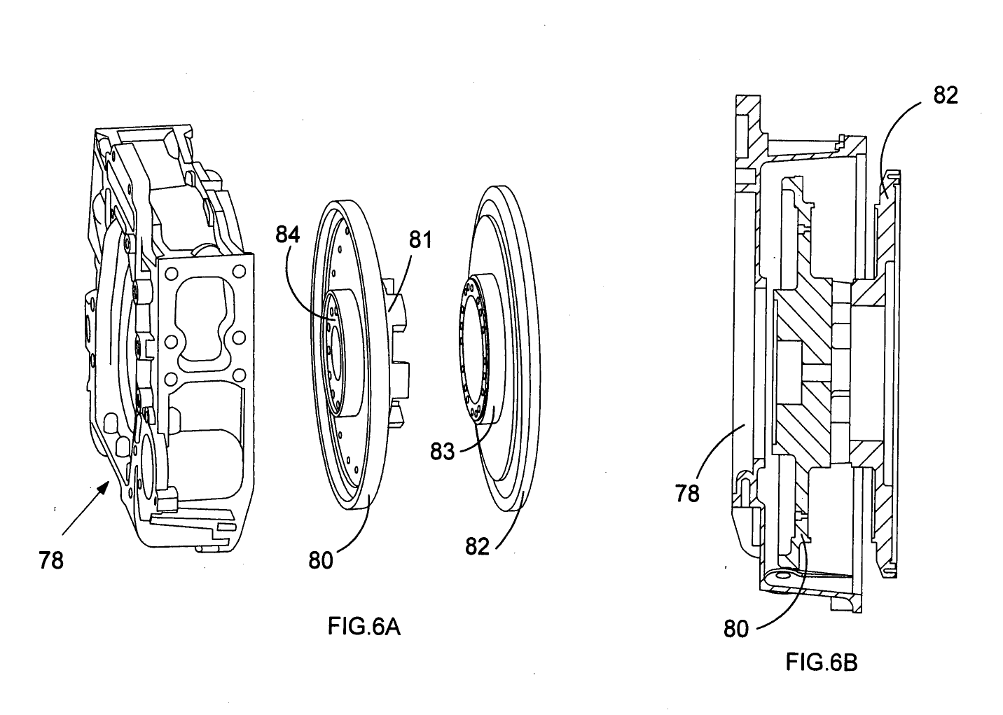

FIG. 10 shows a close-up view of the retention plate of FIG. 9;

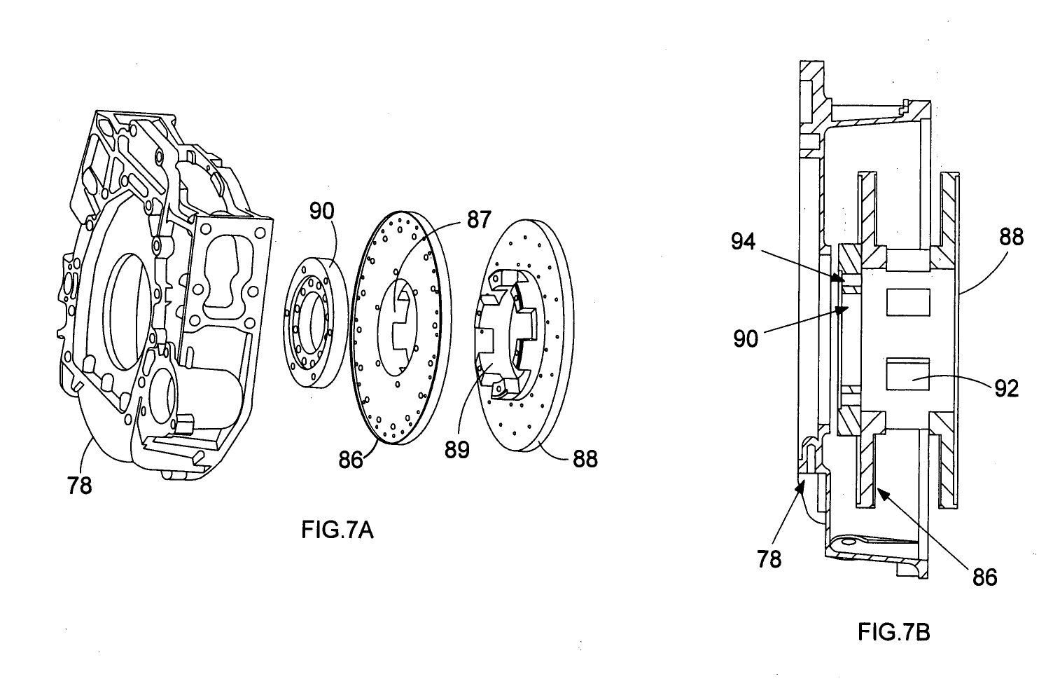

FIG. 11 shows another embodiment of a retention plate;

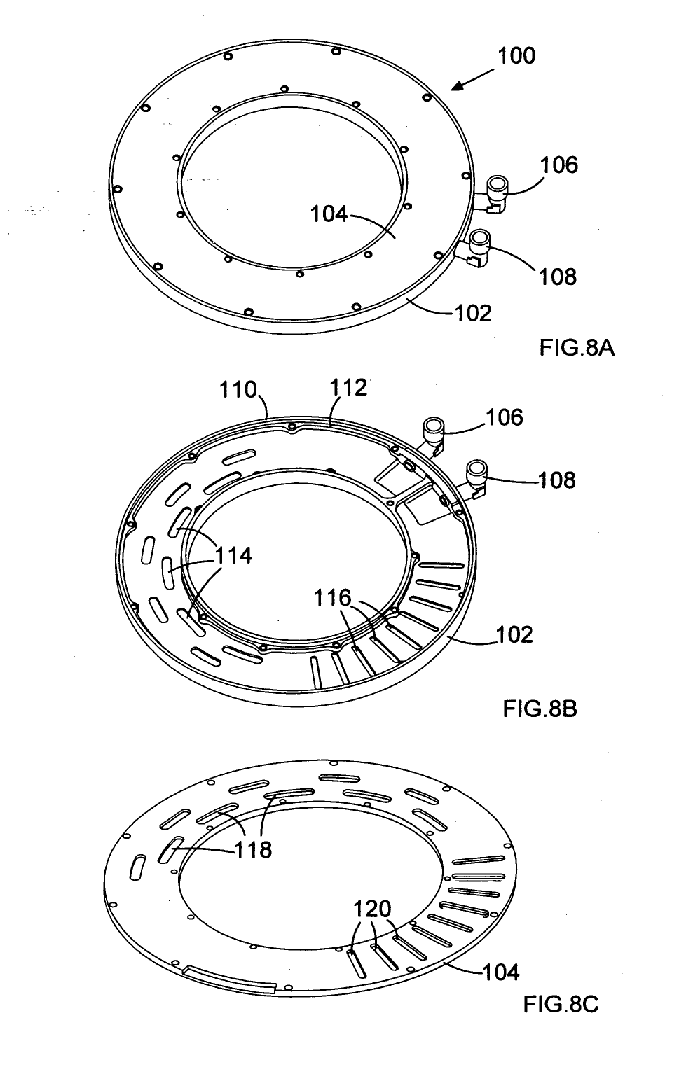

FIGS. 12A to 12D show various arrangements of permanent magnets and ferrous poles;

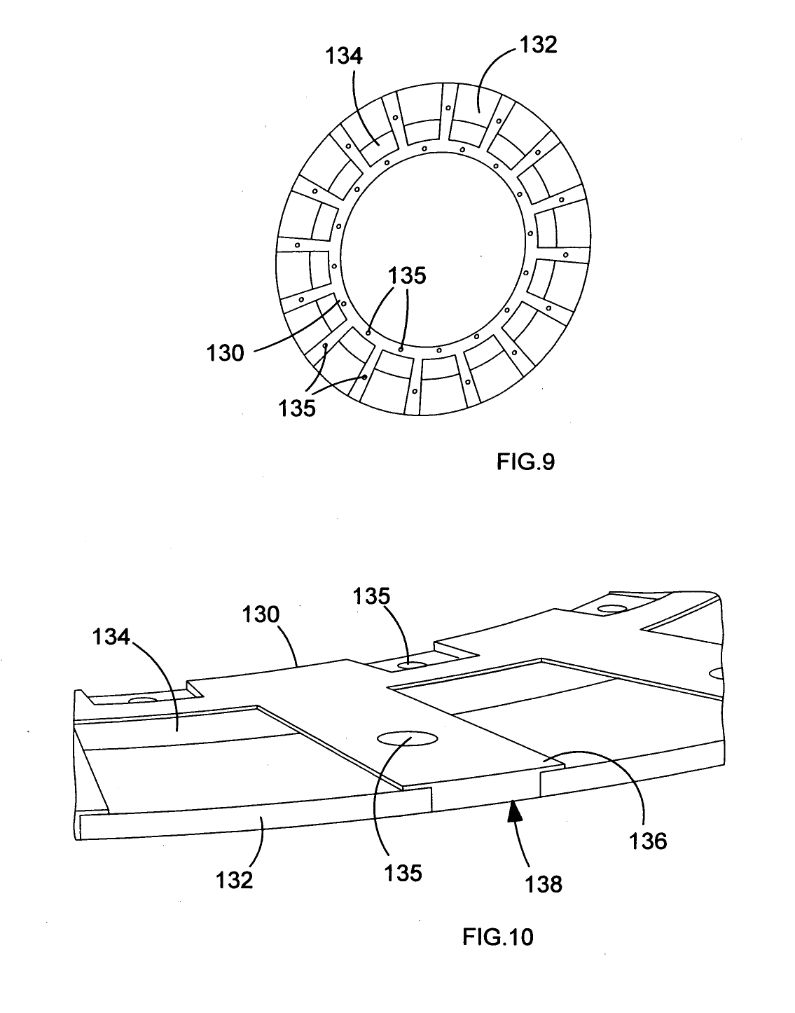

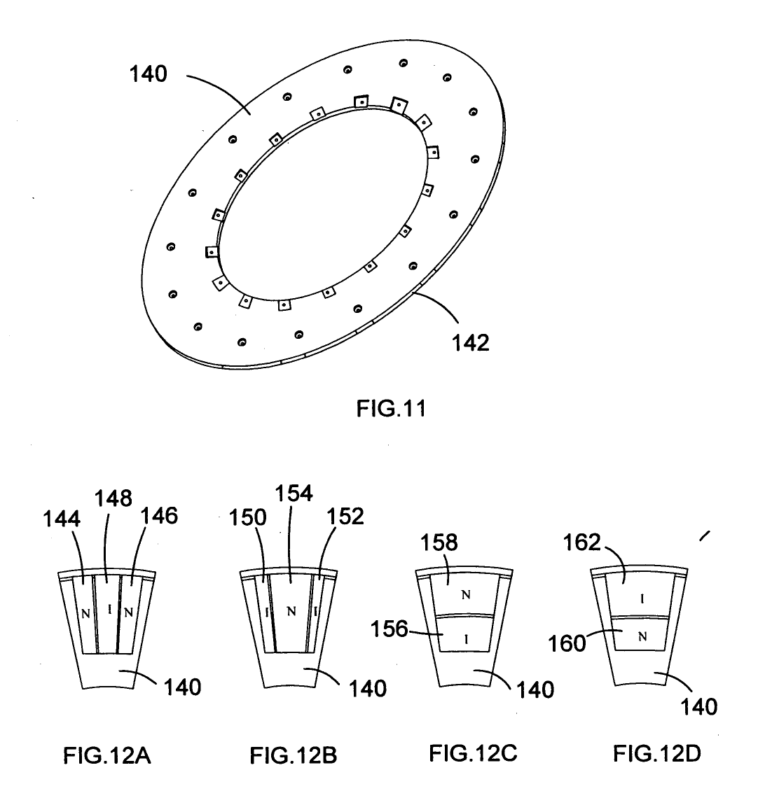

FIGS. 13 and 14 are linear views of a circular cross section through the centre of a rotating electrical machine;

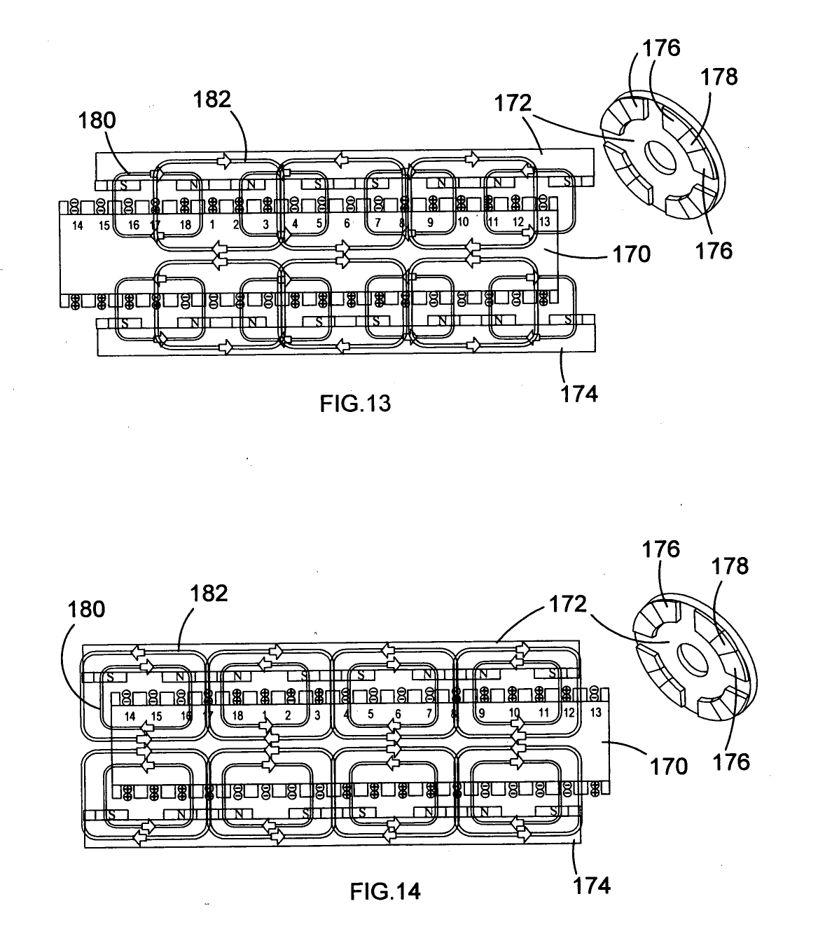

FIGS. 15A and 15B show another embodiment of a magnet retention plate;

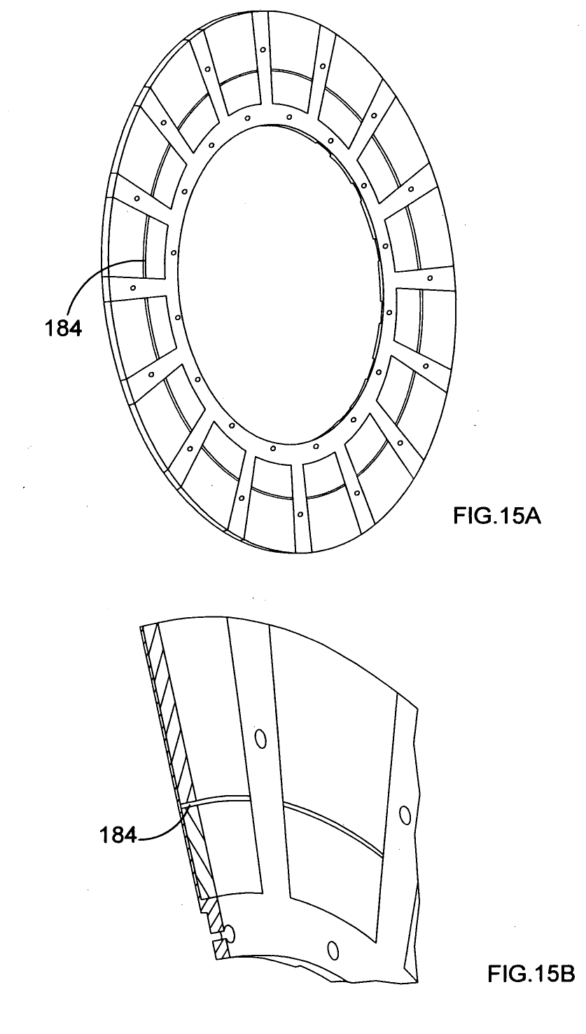

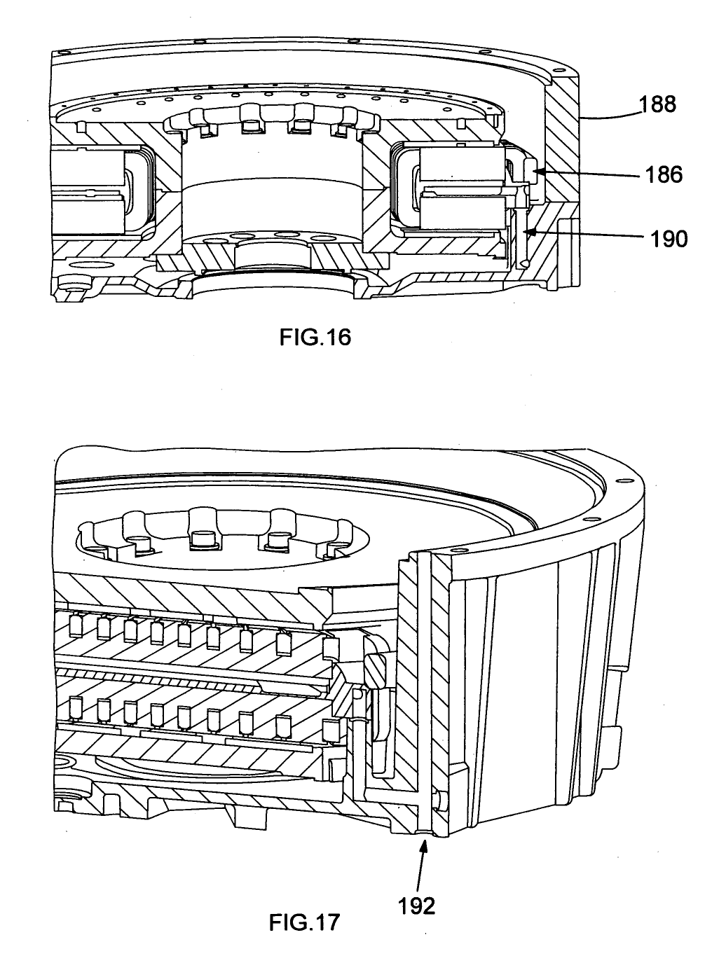

FIGS. 16 and 17 show embodiments of a machine with inlet and outlet pipes integrated in the machine housing; and

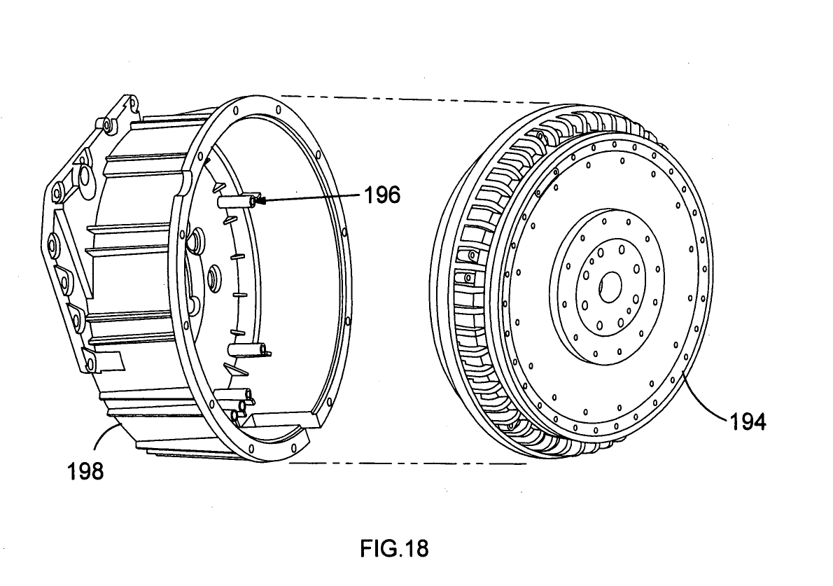

FIG. 18 shows an embodiment of a machine with a stator retention ring integrated with the machine housing.

### OVERVIEW

FIG. 1 shows parts of an axial flux rotating electrical machine. Referring to FIG. 1, the machine comprises a stator 10 sandwiched between two rotor discs 12, 14. The stator 10 consists of two slotted laminated toroids 18, 20 with a cooling jacket 22 sandwiched between the two. The two stator toroids 18, 20 may be manufactured by rolling a single strip of magnetic steel sheet. Slots 23 are formed on one side by an indexed punching machine as the rolling process takes place. Stator windings 24 are wound in the slots in the finished stator.

The rotor discs 12, 14 are mounted on a common shaft, and may be entirely ferromagnetic. Each disc carries a set of permanent magnets 16 with alternate north and south poles directed axially toward the stator. The rotor does not carry alternating flux and it can be constructed conveniently from cast iron. The permanent magnets 16 are preferably sintered Neodymium-Iron-Boron, providing a high magnetic loading, leading to a compact machine design.

The axial machine may be operated either as a generator or as a motor, or both.

### Magnet Retention

FIGS. 2A-2D show how a magnet retention plate may be used to retain permanent magnets on a rotor disc. Referring to FIG. 2A, the magnet retention plate 30 is a ring-shaped disc having a back surface 32, an inner lip 34, an outer lip 36, and a plurality of radial ribs 38. The inner lip 34, outer lip 36 and radial ribs 38 protrude from the back surface 32 in an axial direction. The inner lip 34 and outer lip 36 are both circular, and are located on the inside edge and outside edge of the retention plate respectively.

The back surface 32, inner lip 34, outer lip 36, and radial ribs 38 of the magnet retention plate define a plurality of pockets, each of which is designed to accommodate a permanent magnet. During assembly, the permanent magnets are pushed into the pockets, and are held in the pockets with an interference fit. The radial ribs 38, inner lip 34 and outer lip 36 may include deformable fins 35, or small projections into the pocket, to allow for any tolerance variation and to ensure that the magnets are held in place. FIG. 2B shows a retention plate into which permanent magnets 16 have been inserted.

Once the permanent magnets have been inserted into the magnet retention plate, the plate is offered to the rotor disc, such as rotor disc 12, and fixed to it as shown in FIG. 2C. The retention plate may be fixed to the rotor disc by means of rivets 40, or any other convenient means, such as bolts or screws. FIG. 2D shows the retention plate 30 mounted on the rotor disc 12, and fixed in place with rivets 40. The magnets are completely enclosed, and thus are protected from mechanical damage and from any contamination such as sand or salt which may find its way into the machine.

The retention plate 30 may be formed from a metal such as spring steel, or from a resiliently deformable plastics material such as nylon, or any other suitable material.

The retention plate shown in FIGS. 2A-2D can allow a rotor to be assembled using fewer components than previously known retention techniques, which can reduce the assembly time. The magnets and the retention plate can be offered to the rotor disc as a complete unit, which can facilitate assembly. Furthermore, there is no need to glue the magnets onto the rotor. Any tolerance on the magnets can be absorbed by deformable fins on the retention plate. The fins may support the magnets against torsional forces. Once assembled, the magnets are enclosed and thus mechanically protected against damage.

The retention plate 30 is ideally formed from a material which is non-magnetic, with permeability similar to that of air. In the assembled machine, the back surface 32 effectively replaces part of the air gap between the rotor and stator, and thus by having permeability similar to that of air, the retention means can behave in a similar way electromagnetically to the air gap. This can avoid the need to redesign the machine significantly, and can avoid flux short circuits which might otherwise bypass the air gap.

It is also desirable for the retention plate to be formed from a material which is non-conducting electrically, in order to avoid eddy currents. Ideally, the material would also be thermally conductive, in order to assist with cooling. A suitable material for the retention plate has been found to be reinforced composite plastic, which can be manufactured using a high pressure injection moulding process.

It has been found that the use of the retention plate can allow the tolerances of the air gap to be reduced. This can allow the physical clearance of the air gap to be reduced, which can allow the effective air gap formed by the back surface of the retention plate and the actual air gap to be similar electromagnetically to the case where a retention plate is not used.

### Stator Cooling

Referring back to FIG. 1, it can be seen that the stator 10 is at the centre of the machine, and therefore is likely to experience the highest temperatures. In the arrangement of FIG. 1, a cooling jacket 22 is provided in order to cool the stator.

In the arrangement of FIG. 1, the stator 10 is formed from two parts 18, 20 with the cooling jacket 22 sandwiched between the two. The cooling jacket is disc-shaped, and is hollow to allow a cooling fluid to be circulated through it. Inlet and outlet pipes (not shown in FIG. 1) are provided to allow the cooling fluid to enter and exit the cooling jacket. Any type of cooling fluid may be used, such as engine coolant. The cooling jacket 22 is manufactured from a strong, non-magnetic, heat-conducting material such as aluminium. In one embodiment the cooling jacket is formed from two discs of aluminium which are welded together.

The cooling jacket 22 cools the machine at what is otherwise likely to be the hottest part, namely the centre of the machine. As a consequence it may be possible to rely on the cooling jacket to cool the whole machine. In this case, the machine may be manufactured as a totally enclosed unit.

Conventional rotating electrical machines suffer from the problem that contaminants such as sand and salt may enter the machine, reducing the machine's durability. With permanent magnet machines, the problem of contamination is even more serious, because contaminants can react with the magnets, causing them to rust and deteriorate. A totally enclosed unit has the advantage of being less susceptible to contamination, which may increase the machine's durability. A totally enclosed machine may also be packaged more effectively, as no allowance need be made for air cooling. Furthermore, a totally enclosed unit may be safer, as total containment of rotating components is possible. In addition, a totally enclosed unit may emit less electromagnetic interference, saving the expense of EMI screening.

FIGS. 3A to 3C show parts of the stator 10 and cooling jacket 22 in more detail. FIG. 3A shows the stator 10 with windings 24 in place. Overhang windings 42 are located around the circumference of the stator. An inlet pipe 44 and outlet pipe 46 take coolant into and out of the cooling jacket in the centre of the stator.

FIG. 3B shows a cross sectional view of the stator. The stator is formed of two slotted ring-shaped discs 18, 20 with the cooling jacket 22 sandwiched between the two. FIG. 3C shows the contact surface of the cooling jacket 22 with the stator in more detail. It can be seen that there is only minimal contact between the overhang windings 42 and the cooling jacket 22: This may mean that the overhang windings may not be cooled effectively, which may reduce the efficiency of the machine.

Another embodiment of the cooling jacket is shown in FIGS. 4A-4E. The cooling jacket of FIGS. 4A-4E is designed to be more effective in cooling the machine.

FIG. 4A shows an exploded view of the cooling jacket. Referring to FIG. 4A, the cooling jacket is formed from two sections 48, 50 which, when pressed together, form an annular cavity in their centre. Each of the two sections 48, 50 has two circular grooves which accommodate O-rings 52, 54. The O-rings seal the two sections 48, 50, so that coolant flowing in the cavity will not leak out.

The first section 48 of the cooling jacket carries a plurality of heat sink fins 56 around its circumference. The fins 56 are in the form of axially-running semi-cylinders on a ring around the outside surface of the first section. The space between the fins is designed to accommodate the stator windings. The outside surface of the cooling jacket between the fins is curved to fit with the curvature of the windings. Every sixth fin is longer than the others in an axial direction, and has a hole at each end.

The second section 50 of the cooling jacket has similar, but smaller, fins 58 around its inside edge. The fins 58 are in the form of axially-running semi-cylinders around the inside surface of the first section. The spaces between the fins 58 are designed to accommodate the inside of the stator windings, and the inside surface between the fins is curved to fit with the curvature of the windings. Some of the fins 58 are extended, and have bolt holes through the extended portions.

Thus, the assembled cooling jacket has an essentially annular shape, with axially running fins on both the inside and outside surfaces, and curved surfaces between the fins.

FIG. 4B shows a cross sectional view of part of the assembled cooling jacket in place inside the stator. The cross section of FIG. 4B is taken through the extended fins. The two sections 48, 50 of the cooling jacket are pushed together between two stator sections 60, 62. The bolt holes in the extended fins on the second section may be used to help secure the cooling jacket to the stator.

FIG. 4C shows the stator with windings 65 and overhang windings 66 in place. The windings sit on the curved surfaces between the fins on both the inside and outside of the cooling jacket. The windings help to hold the stator and cooling jacket together. An inlet pipe 63 and outlet pipe 64 take coolant into and out of the cooling jacket.

FIG. 4D shows a more detailed view of the stator assembly. It can be seen that the windings 65 slot into the grooves between the fins 56, while the overhang windings 66 lie on top of the fins 56. Thus the fins 56 have a relatively large contact area with the windings 65, 66. The fins 56 act as a heat sink feature, and conduct heat away from the windings towards the coolant in the cooling jacket. The inside windings 68 slot into the grooves between the inside fins 58, and thus the inside fins conduct heat away from the inside windings.

In order to prevent rotation of the stator, roll pins 70 are inserted through the holes in the longer fins into the stator. FIG. 4E shows a cross sectional view of the stator with the roll pins 70 in place.

The modified cooling jacket shown in FIGS. 4A-4E may provide better cooling due to the extension of the inner and outer diameter of the cooling jacket. The cooling jacket has a larger contact area with the windings, which increases cooling efficiency. The production method may be cheaper, since most of the features can be cast which avoids the expense of machining. Furthermore, the two sections of the cooling jacket can be joined together without the need for welding. The cooling jacket is preferably made from a strong, non-magnetic, heat conducting material such as aluminium.

The axial flux machine described above may be connected to an engine in order to be driven as a generator. In this case, the cooling jacket may be connected to the engine's cooling system, so that the engine's coolant is also passed through the cooling jacket. This can remove the need to provide a separate cooling system (pump, radiator etc.) for the cooling jacket.

FIG. 16 shows another embodiment, in which the inlet and outlet pipes are integrated with the heatsink and the machine housing. Referring to FIG. 16, the stator 186 is shown in place inside the machine housing 188. An inlet pipe 190 is provided inside the machine for taking coolant into the stator cooling jacket. A similar outlet pipe is also provided for taking coolant out of the stator cooling jacket. This arrangement can allow the total number of components to be reduced, and assembly of the machine to be simplified.

FIG. 17 shows another embodiment with integrated inlet and outlet pipes. Referring to FIG. 17, a coolant path 192 is provided as part of the heatsink and machine housing, which can facilitate the supply of coolant from outside of the machine to and from the cooling jacket.

FIGS. 8A-8C show another embodiment of a cooling jacket for an axial flux rotating electrical machine. The cooling jacket of FIGS. 8A-8C is designed to provide a more uniform transfer of heat from the stator core, while maintaining a low pressure drop in the coolant.

FIG. 8A is an external view of the cooling jacket 100. The cooling jacket is formed from a rear plate 102 and a front plate 104 which, when connected together, form a passage with a high aspect-ratio cross-section. An inlet pipe 106 takes coolant into the passage, and an outlet pipe 108 takes coolant out of the passage. The coolant runs in an anti-clockwise direction through the cooling jacket passage.

FIG. 8B shows the rear plate 102 without the front plate. The rear plate 102 has a projecting rim 110 around its circumference which is designed to accommodate the front plate 104. A lip 112 creates a gap between the front plate 104 and the inside surface of the rear plate 102, in order to form the passage for the coolant. The inside surface of the rear plate 102 has a first series of milled grooves 114 and a second series of milled grooves 116. The grooves 114 run parallel to the flow of coolant, while the grooves 116 run perpendicular to the flow of coolant.

FIG. 8C shows the inside surface of the front plate 104. Thus the view of FIG. 8C is from the opposite side of the front plate to that of FIG. 8A. The front plate 104 is designed to fit inside the rim 110 and on top of the lip 112 of the rear plate 102. The inside surface of the front plate 104 has a first series of milled grooves 118 and a second series of milled grooves 120. The grooves 118 run parallel to the flow of coolant, while the grooves 120 run perpendicular to the flow of coolant.

In the cooling jacket of FIGS. 8A-8C, the grooves 114, 116, 118, 120 introduce turbulence in the flow of coolant through the passage. A different amount of turbulence is introduced by different grooves in different parts of the passage in order to maintain a similar level of heat transfer along the trajectory of the coolant.

Early after entry of the coolant into the passage, turbulence is high and no augmentation of the turbulence is needed. Between approximately 20-60% of the distance traveled by the coolant around the passage, moderate augmentation is achieved by the first series of milled grooves 114, 118, which are parallel with the flow of coolant. From 70-90% of the distance traveled by the coolant, a higher level of flow disturbance is required and is achieved by the series of cross-flow milled grooves 116, 120. The last 10% of the distance traveled by the coolant sees a drop in heat transfer rate from wall to coolant, but this is compensated by high conductivity of the cooling jacket material (aluminium) to transfer heat from the water outlet region to the water inlet region.

In FIGS. 8B and 8C, the depth of grooves is approximately equal to half of the width of the passage. The use of grooves has been found to be superior in terms of resulting pressure drop across passage, compared to the use of ribs. Similar heat transfer improvement may be achieved with grooves as would be with ribs. The mutual positions of the grooves can be arrived at by considering the distance it takes for an effect of each new thermal boundary layer to diminish. The arrangement shown in FIGS. 8A-AC has been designed for a flow rate in the range of 5 to 20 litres per minute.

The milled grooves shown in FIGS. 8A-8C may also be provided with the cooling jacket of FIGS. 3A-3C and 4A-4E.

### Stator Retention

Referring back to the schematic diagram of an axial flux machine in FIG. 1, it can be seen that some arrangement is need to hold the stator 10 in place. FIGS. 5A-5D show parts of a stator retention assembly.

FIG. 5A shows a retaining ring which may be used to retain a stator assembly. The retaining ring has a plurality of teeth 74 extending radially inwards on one edge.

FIG. 5B shows an exploded view of the stator assembly and the retaining ring. The stator assembly is formed from a cooling jacket sandwiched between two stator sections, as discussed above with reference to FIGS. 4A-4E. As can be seen from FIG. 5B, some of the fins on the outside part of the cooling jacket extend outwards in a radial direction next to the overhang windings. The teeth 74 of the retaining ring 72 are designed to engage with the extended fins 76.

FIG. 5C is a cross sectional view of the stator assembly in place on the retaining ring. As can be seen from FIG. 5C, holes in the retaining ring teeth 74 are aligned with holes in the extended fins 76. This allows the stator assembly to be bolted to the retaining ring. An end view of the assembled stator and retaining ring is shown in FIG. 5D.

In the stator retention assembly shown in FIGS. 5A-5D, the stator assembly is held in place by bolting the cooling jacket to the retention ring, rather than clamping the stator. This means that the retaining ring is not in the main magnetic field, which reduces eddy current losses. Furthermore, by bolting the stator assembly rather than clamping it, the risk of stator rotation under short circuit conditions is reduced. Roll pins are inserted between the cooling jacket and stator as shown in FIG. 4E, to further reduce the risk of stator rotation. Since the retention ring is not in direct contact with the stator, the risk of damaging the stator end windings is reduced. Furthermore, the retention assembly shown in FIGS. 5A-5D is easier to assemble than the previously considered techniques, and uses fewer components.

FIG. 18 shows another embodiment in which the stator retention ring is integrated with the machine housing. In this embodiment, the stator assembly 194 is retained by bolting the cooling jacket directly to mountings 196 in the machine housing 198. This reduces the number of parts and facilitates manufacture of the machine.

In the embodiments of FIGS. 4A-4D, 5A-5D and 18, the cooling jacket is shown with both extended fins and non-extended fins. However in other embodiments only the extended fins are provided, and the non-extended fins are omitted. In these embodiments the extended fins are used to secure the stator assembly.

### Rotor Design

As discussed above, the axial machine described above may be connected to an engine in order to be driven as a generator. An advantage of the axial machine configuration is that the machine can be readily integrated with the engine in order to produce a single unit. For example, the axial machine may replace the engine flywheel, and may sit inside the flywheel housing. This may result in a more compact design with fewer components.

FIGS. 6A and 6B show a previously considered rotor design for integration of the axial machine into an engine flywheel housing. FIG. 6A shows an exploded view of a flywheel housing 78 and the rotor. Referring to FIG. 6A, the rotor consists of a driven-end rotor disc 80 and a non-driven-end rotor disc 82. Each rotor disc has a connecting ring 81, 83 for connecting the two discs together. The connecting ring 81 on the driven-end rotor disc 80 is castellated, while the connecting ring 83 on the non-driven-end rotor disc 82 is non-castellated. A crank bolting face 84 is provided on the driven-end rotor disc 80 for connecting the rotor to the engine crank shaft. FIG. 6B shows the assembled rotor inside the flywheel housing.

A problem with the rotor design shown in FIGS. 6A and 6B is that the driven-end and non-driven-end rotor discs have different dimensions, so that casting and machining is expensive. Another problem is that the rotor is only designed to fit onto a particular type of engine. In practice, it may be desirable to fit the machine to a number of different engines. For example, a number of different SAE (Society of Automobile Engineers) flywheel housing types are defined, and it may be desirable to fit the machine to any number of these. This requires either a large inventory of different machines for different engines, or replacement of the rotor for fitting to different engines, neither of which is desirable. A further problem is that there is little air flow during rotation of the rotors.

FIGS. 7A and 7B show parts of an improved rotor design. FIG. 7A shows an exploded view of the rotor and flywheel housing. The rotor comprises a driven-end rotor disc 86, a non-driven-end rotor disc 88, and an adaptor hub 90. Each rotor disc has a connecting ring 87, 89 for connecting the two discs together. FIG. 7B shows the assembled rotor inside the flywheel housing.

In the arrangement of FIGS. 7A and 7B, the driven-end rotor disc 86 and non-driven-end rotor disc 88 are symmetrical, and each is formed from a similar or identical part. Since the two parts are symmetrical, the cost of casting and machining the two parts can be reduced, which may reduce the manufacturing cost.

In contrast to the arrangement shown in FIG. 6A, in the arrangement of FIGS. 7A and 7B each connecting ring 87, 89 is castellated. In the assembled rotor the castellations are aligned to create air gaps 92, as shown in FIG. 7B. This can allow more air flow between the stator and the magnets during rotation of the rotor, which may improve the rotor cooling. Alternatively; both connecting rings may be non-castellated in a similar way to the non-driven-end rotor disc 82 shown in FIG. 6A.

The adaptor hub 90 is used to connect the rotor to the engine crank shaft. The adaptor hub 90 is a separate piece which is connected to the driven-end rotor disc. The adaptor hub is designed in such a way that by varying the hub pitch circle diameter 94 it is possible to connect the hub to engines of a different size. This can allow the axial flux machine to be connected to a number of different engines simply by replacing the adaptor hub.

Advantages of the rotor design shown in FIGS. 7A and 7B include easy assembly, more air flow during rotation due to the castellation feature on the non-drive-end rotor disc, the ability to maintain the tolerance on the rotors more accurately, lower manufacturing costs, and less inventory management.

### Field Control

FIG. 9 shows another embodiment of a magnet retention plate. The magnet retention plate is in the form of a semi-closed retention spider 130. In FIG. 9, a plurality of permanent magnets 132, and a plurality of ferrous poles 134 are located within the retention plate. For clarity, the rotor itself and fasteners such as bolts, washers and so forth are not illustrated.

In the arrangement of FIG. 9, the permanent magnets 132 are arranged around the retention plate 130 in a north-south arrangement (i.e. with the poles of alternate magnets facing in the opposite direction). A ferrous pole 134 is positioned adjacent to each permanent magnet. The combination of a permanent magnet 132 and a ferrous pole 134 forms a main magnetic pole.

The ferrous poles 134 are formed from a material of high permeability, and are non-magnetised. A suitable material may be a ferromagnetic metal such as steel or iron, although other materials such as nickel, cobalt and manganese, or their compounds, could be used instead. Alternatively, the ferrous poles may be formed from a powder of ferromagnetic metal, such as iron, embedded in resin.

During assembly of the rotor, the permanent magnets 132 and ferrous poles 134 are pushed into the retention plate, and are held in place by an interference fit. The retention plate may include deformable fins which project inwards towards the magnets and ferrous poles, to allow for any tolerance variation and to ensure that the magnets and ferrous poles are held in place. Once the magnets and ferrous poles have been inserted into the retention plate, the plate is offered to the rotor disc as a complete unit. Holes 135 are provided in the retention plate 130 for securing it to the rotor. The retention plate may be fixed to the rotor disc by means of rivets or any other convenient means, such as bolts or screws. The rotor disc is provided with a lip around its outside circumference in order to retain the magnets and ferrous poles radially in the assembled rotor.

FIG. 10 shows a close-up view of the semi-closed magnet retention plate 130. Referring to FIG. 10, the retention plate comprises a back surface 136 and protrusions 138. The protrusions 138 define pockets into which the magnets 132 and ferrous poles 134 can be inserted. In the assembled rotor, the back surface 136 retains the magnets axially, while the protrusions 138 retain the magnets tangentially.

FIG. 11 shows another embodiment of the retention plate. In the arrangement of FIG. 11, the back surface 140 of the retention plate is closed. Permanent magnets 142 are located in the retention plate. In the view of FIG. 11, ferrous poles are hidden under the closed rear surface of the retention plate 140.

In the arrangement of FIGS. 9 to 11, the ferrous poles provide a field weakening capability through a reluctance torque. This is achieved by passing a control current through a control winding, in the way described in WO 03/003546. The arrangement of FIGS. 9 to 11 can therefore allow control of the rotor field.

If the electrical machine is used as motor or in the power train of a vehicle, the speed is constrained by the maximum speed of the transmission, and the maximum-to-nominal speed ratio is selected for optimal transmission speed and thermal performance. Above the nominal motor speed, field weakening is applied to achieve constant-power operation. This field weakening allows the constant power region to be extended at high speed, and while keeping the terminal voltage at rated value. It can also assist the main torque at low speeds. This can be achieved by controlling appropriately the d-axis current component of the d-q vector control technique. Therefore the rotor discs are provided with saliencies and the inductance in the q-direction is different than the inductance in the d-direction.

FIGS. 12A to 12D show various ways in which a permanent magnet and ferrous pole may be arranged to form a main magnetic pole. In FIG. 12A, two permanent magnets 144, 146 are arranged either side of ferrous pole 148 in a circumferential direction. In the arrangement of FIG. 12B, two ferrous poles 150, 152 are arranged either side of a permanent magnet 154. In the arrangement of FIG. 12C a ferrous pole 156 is located radially inwards of a permanent magnet 158, while in the arrangement of FIG. 12D a permanent magnet 160 is located radially inward of a ferrous pole 162. In each case the combination of one or more permanent magnet and one or more ferrous pole forms a main magnetic pole which can achieve field weakening by passing the appropriate current through a control winding.

FIGS. 13 and 14 are linear views of a circular cross section through the centre of a rotating electrical machine. Referring to FIGS. 13 and 14, the machine comprises a stator 170, a first rotor plate 172 and a second rotor plate 174. Permanent magnets 176 and ferrous poles 178 are arranged around the rotor plates in the way shown in FIG. 12(a). A magnetic flux 180 is established by the permanent magnets 176. A control winding (not shown) is also provided in the stator in order to establish an armature current flux 182 through the ferrous poles. In FIG. 13 the armature current flux 182 is in quadrature with the magnetic flux 180, while in FIG. 14 the armature current flux 182 opposes the magnetic flux 180.

As an example, if the electrical machine is used as motor or in the power train of a vehicle, the machine may be operated at constant Volts/Hertz operation up to the base speed (say 20% of the maximum-speed) to provide the required constant torque. In this range, vector control may be used to set the flux produced by the armature current in the q-direction to be in quadrature with the flux generated by the magnet, as shown in FIG. 13. In this case the armature current is in phase with the back emf voltage of the motor. This can allow optimum: torque production to be achieved.

Above the base speed and up to the maximum speed, the vector control technique can be used to weaken the air-gap flux by controlling the amount of flux produced by the armature current in the d-direction, as depicted in FIG. 14. This can allow constant voltage operation to be maintained up the maximum speed.

FIGS. 15A and 15B show another embodiment of a magnet retention plate. In this embodiment, a spacing ring 184 is included as an integrated feature of the magnet retention plate. This helps to prevent leakage flux from the permanent magnets from crossing to the ferrous poles without linking with the windings of the stator.

In the above description various different embodiments of an axial flux rotating electrical machine have been described. It will be appreciated that the various embodiments are complementary, and that features of one embodiment may be provided with any of the other embodiments.

1. Retention means for retaining magnets on the rotor of an axial flux rotating electrical machine, the retention means comprising a back plate with a plurality of protrusions, the protrusions defining a plurality of pockets for accommodating the magnets, wherein the retention means is arranged such that the magnets can be inserted into the pockets and held therein, and wherein the retention means with inserted magnets can be fixed to the rotor so as to retain the magnets axially and tangentially.

2. Retention means according to claim 1 wherein at least some of the protrusions are in the form of ribs.

3. Retention means according to claim 1, wherein at least some of the protrusions run in a substantially radial direction.

4. Retention means according to claim 1, wherein at least some of the protrusions include deformable fins which extend inwards.

5. Retention means according to claim 1, wherein the retention means is arranged to be mounted on the rotor with the magnets facing a back plate of the rotor.

6. Retention means according to claim 1, wherein the retention means is arranged such that, when it is mounted on the rotor, the magnets are at least partially encased by the retention means and the rotor.

7. Retention means according to claim 1, wherein the back plate is a ring-shaped disc.

8. Retention means according to claim 1, wherein the retention means is in the form of a semi-closed spider.

9. Retention means according to claim 1, further comprising means for retaining the magnets radially.

10. Retention means according to claim 1, further comprising a lip for retaining the magnets.

11. Retention means according to claim 1, further comprising a spacing ring for separating radially spaced magnets and/or ferrous poles.

12. A rotor assembly for an axial flux rotating electrical machine, the rotor assembly comprising:
a rotor disc;
a plurality of permanent magnets; and
retention means according to claim 1.

13. A rotor assembly according to claim 12, wherein the rotor disc includes a lip for retaining the magnets.

14. A rotor assembly according to claim 12, further comprising a plurality of ferrous poles which are retained on the rotor by the retention means.

15. A rotor assembly according to claim 14, wherein each ferrous pole is adjacent to a permanent magnet.

16. A rotor assembly according to claim 14, wherein the ferrous poles allow control of the rotor field.

17. A rotor assembly according to claim 12, the rotor assembly comprising two rotor discs for mounting on either side of a stator, wherein the rotor discs are symmetrical.

18. A rotor assembly according to claim 17, wherein each rotor disc comprises a castellated connecting ring.

19. A rotor assembly according to claim 18, wherein the castellated connected rings are aligned to create air gaps in the rotor.

20. A rotor assembly according to claim 12, further comprising an adaptor hub for connecting the rotor assembly to an engine.

21. A method of assembling a rotor for an axial flux rotating electrical machine, the method comprising inserting magnets into pockets in a retention means, offering the retention means with inserted magnets to a rotor disc, and fixing the retention means to the rotor disc such that the magnets are held between the rotor and the retention means in order to retain the magnets axially and tangentially.

22. A cooling jacket for a stator of an axial flux rotating electrical machine, the cooling jacket being arranged to cool the inside of the stator, the cooling jacket comprising a passage for the flow of coolant, wherein the passage comprises grooves which introduce turbulence into the flow of coolant.

23. A cooling jacket according to claim 22, wherein the grooves introduce different amounts of turbulence in different parts of the passage.

24. A cooling jacket according to claim 22, wherein the grooves are arranged to introduce an increasing amount of turbulence through the passage in the direction of coolant flow.

25. A cooling jacket according to claim 22, wherein the grooves are arranged such that a similar level of heat transfer is achieved throughout the cooling jacket.

26. A cooling jacket according to claim 22, wherein some grooves run at different angles to the flow of coolant from other grooves.

27. A cooling jacket according to claim 22, wherein grooves running substantially parallel to the flow of coolant are provided in a first part of the cooling jacket, and grooves running substantially perpendicular to the flow of coolant are provided in a second part of the cooling jacket.

28. A cooling jacket according to claim 22, wherein some grooves are more closely spaced than others.

29. A cooling jacket according to claim 22, wherein the cooling jacket is formed from two sections which, when pressed together, form an annular cavity.

30. A cooling jacket according to claim 29 wherein the two sections are sealed by at least one O-ring seal.

31. A cooling jacket according to claim 29, wherein the two sections are at least partially held together by stator windings.

32. A cooling jacket according to claim 22, further comprising a plurality of fins which extend beyond the circumference of the stator.

33. A cooling jacket according to claim 32, wherein the fins act as heat sinks for stator windings.

34. A cooling jacket according to claim 32, wherein the fins define slots which accommodate stator windings.

35. A cooling jacket according to claim 32, wherein the fins extend radially outwards such that, when the stator is wound, overhang windings rest on the fins.

36. A cooling jacket according to claim 32, wherein at least some of the fins are arranged for securing the stator to the machine.

37. A cooling jacket according to claim 32, wherein some of the fins extend outwards in a radial direction by a greater amount than the other fins, and the extended fins are used for securing the stator to the machine.

38. An axial flux rotating electrical machine comprising:
a machine housing;
a stator;
a cooling jacket according claim 22; and
an inlet pipe and an outlet pipe for supplying coolant to and from the cooling jacket, wherein the inlet pipe and outlet pipe are integrated with the machine housing.

39. An axial flux rotating electrical machine comprising:
a stator;
a cooling jacket inside the stator for cooling the stator; and
stator windings around the stator and the cooling jacket;
wherein the cooling jacket comprises a plurality of independent protrusions which extend radially outwards through the stator windings and which secure the stator to the machine.

40. An axial flux machine according to claim 39, wherein the protrusions are in the form of extended fins.

41. An axial flux machine according to claim 39, wherein the stator and/or cooling jacket comprise open slots for accommodating the stator windings.

42. An axial flux machine according to claim 39, further comprising roll pins inserted between the cooling jacket and the stator.

43. An axial flux machine according to claim 39, further comprising a retention ring, wherein the cooling jacket is secured to the retention ring.

44. An axial flux machine according to claim 43, wherein the retention ring comprises a plurality of teeth aligned with the protrusions on the cooling jacket.

45. An axial flux machine according to claim 39, further comprising a machine housing, wherein the stator is enclosed within and/or secured to the machine housing.

46. An axial flux machine according to claim 45 further comprising a retention ring, wherein the cooling jacket is secured to the retention ring, wherein the retention ring comprises a plurality of teeth aligned with the protrusions on the cooling jacket, and wherein the retention ring is integrated with the machine housing.

47. An axial flux machine according to claim 46, further comprising an inlet pipe and an outlet pipe for supplying coolant to and from the cooling jacket, wherein the inlet pipe and outlet pipe are integrated with the machine housing.

48. A generator set comprising:
an axial flux rotating electrical machine according to claim 38; and
an engine coupled to the electrical machine, the engine comprising a cooling system, wherein the cooling jacket is connected to the engine cooling system to allow flow of coolant from the engine cooling system through the cooling jacket.

49. A generator set according to claim 48, wherein the engine has a flywheel housing, and the electrical machine is integrated in the engine flywheel housing.

50. An axial flux rotating electrical machine comprising retention means according to claim 1 or a rotor assembly according to claim 12, and/or a cooling jacket according to claim 22, and/or the machine of claim 38.

51. A method of assembling an axial flux rotating electrical machine, the method comprising:
providing a stator assembly comprising two stator parts;
providing a cooling jacket, the cooling jacket comprising a plurality of independent radial protrusions;
placing the cooling jacket between the two stator parts;
winding stator windings around the stator and cooling jacket; and
securing the stator to the machine by means of the protrusions from the cooling jacket.

52. An axial flux machine according to claim 45, further comprising a retention ring, wherein the cooling jacket is secured to the retention ring and wherein the retention ring is integrated with the machine housing.
